(19) United States
(12) Patent Application Publication
(10) Pub. No.: US 2007/0073963 A1
(43) Pub. Date: Mar. 29, 2007

(54) Class allocation for volatile files

(75) Inventors: Wilhelmus Franciscus Johannes Fontijn, EINDHOVEN (NL); Declan Patrick Kelly, Eindhoven (NL); Wilhelmus Jacobus Van Gestel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,380

(22) PCT Filed: Dec. 3, 2003
(86) PCT No.: PCT/IB03/50030

§ 371 Date: Jun. 15, 2005

(30) Foreign Application Priority Data
Dec. 20, 2002 (EP) 02080522.2

(51) Int. Cl. G06F 13/00

(52) U.S. Cl. 711/111

(57) ABSTRACT

The present invention relates to a storage device, a storing method and rewritable record carrier for storing data file, wherein a rewriting frequency of the date files is identified and the data files are classified based on their identified rewriting frequency. Each data file is then written using a rule selected according to the result of classification. The definition of the allocation class and rules based on the rewriting frequency enables an optimization of the file storage for endurance and power consumption. Thereby, the life time of the storage medium and the battery life of the whole system can be extended.

Fuelled by multimedia requirement for text, images, video and audio, storage requirements are growing at an exponential rate. To meet this need, the hierarchy of on-line, near-line and off-line storage systems will be composed of many diverse technologies such as persistent memories, magnetic disc drives, magnetic tape drives and tape libraries, optical disk drives and optical libraries. The mix of these sub-systems will be very application-specific so as to optimize the performance and cost of the overall system.

An optical storage system is a particularly attractive component of this hierarchy because it provides data access times in an intermediate range between a hard disc drive (HDD) and a tape drive. Access time is the time, including latency, required to start retrieving a random block of data and typically ranges from less than 10 ms for a hard disc drive, to 30 ms until about 1 s for an optical disc drive, and several seconds until several minutes for a tape drive. The access time becomes an important link in the chain as data are staged up and down between central processing unit, memory, and storage.

Perhaps the most enabling feature of optical storage is the removability of the storage medium. With separations of a few millimeters between the recording surface and the optical head, and with active servos for focussing and tracking, the medium can be removed and replaced with relatively loose tolerances. The infamous head crashes regularly experienced in HDDs do not occur in optical drives. Data reliability and removability are further enhanced by using a transparent disc substrate as a protective cover to keep contamination away from the recording surface, and by ECC (Error Correction Coding), data interleaving, and EFM (Eight-to-Fourteen Modulation) encoding.

Phase change and magneto-optical discs are e.g. used in WORM (Write-Once-Read-Many) and read/write/erase systems where a single disc can contain almost 5 GB. File systems have started using allocation classes as a way of storing specific types of files in a specific way and/or on a specific location. Such a specific type of files may be real-time files. The use of allocation classes is useful especially if the storage medium or device has certain properties that limit the performance on a certain aspect. Examples of such a device include optical drives, in particular small form factor optical storage (SFFO). Recent advances in blue laser technology, and innovations in the area of optical storage media and miniaturized opto-mechanics have paved the way towards SFFO drives. The resulting high storage density can be exploited to reduce the disc size while still providing a high storage capacity, e.g. 1 GB on a disc of 3 cm diameter. To fulfil the stringent space requirements of portable devices, all dimensions need to be reduced, particularly the building height. This issue is addressed by the drastically miniaturized SFFO systems. In these systems, a small objective lens made of plastic, instead of glass, is used, allowing greater design freedom and hence a smaller drive height. Moreover, an ultra-thin version of the actuator which positions and focuses the laser beam onto the optical disc has been developed. Using these miniature key components, fully functional optical drives of just 5.6×3.4×0.75 cm³ have been realized.

There have always been files which are accessed more than others, e.g. configuration files which may be read and written each session. With storage devices that have traditionally been used as full random access devices, typically HDDs, this has never been an obvious problem as they have not been constrained with regard to power consumption or recyclability, i.e. endurance of the medium. Files which are written often are called volatile files. The optimizations for files that are read often are slightly different. These are better covered by the optimizations for start-up files. Some files may be both written often and read often.

Until recently, optical discs have not been used intensively as true random access devices. With the introduction of transparent defect management and speed up of read and write cycles for optical discs, this type of use is expected to be intensified. Multiple portable device types, e.g. mobile phones, are expected to have only SFFO for mass storage. Their use will in some cases mimic that of a HDD in a personal computer (PC). However, the recyclability of optical discs is still very limited compared to HDDs. Repeated writing of the same file on the same location will thus cause problems. For instance, a feature rich phone book which keeps track of all calls, will be written multiple times a day. Consequently, the recyclability budget will be used up in a matter of months. In addition, portable platforms are notorious for their limited power supply. Therefore, measures to reduce power consumption are highly valuable.

It is therefore an object of the present invention to provide an allocation scheme for volatile files, by means of which the rewriting behavior and power consumption of such rewritable recording media can be improved.

To this end a storage device is provided for storing a data file on a rewritable recording medium (10), said device comprising: identification means (30) for identifying a rewritingfrequency of said data file; classification means (60) for classifying said data file based on said identified rewriting frequency; and writing means (20) for writing said data file on said rewritable recording medium (10) using a rule selected according to the classification of said data file.

Accordingly, by defining an allocation class based on the rewriting frequency, e.g. a volatile file allocation class, and rules for storing such files, the storage can be optimized with regard to endurance and power consumption. Thereby, the lifespan of the storage medium as well as the battery life of the whole system can be extended.

The classifying means may be adapted to classify the data file as a volatile file, if it is written more than a predetermined ratio of the recyclability of the recording medium.

Furthermore, the identifying means may be arranged to identify the rewriting frequency by determining the amount of time until the data file has been re-written, or the number of times the data file is written within a predetermined time-period. Alternatively or additionally, the identifying means may be arranged to identify the rewriting frequency based on the type of the data file. Thereby, the identification of a file as a volatile file can be done a priori or during file system operations.

The selected rule used by the writing means may define a relocation frequency and/or a write optimization for reduced power consumption. In particular, the write-optimization rule may define the location of a storage area on the recording medium. Thus, during rewriting, a volatile file can be written to a different location than the previous version of the same file. To thereby ensure that the volatile file is not written to the original location again. This improves endurance of the recording medium. Moreover, the power conservation rule may define an area on the outside of the disc as the storing area for volatile files to thereby improve the read and write speed of the volatile files which are accessed at a relatively high frequency, i.e. well above the average frequency.

The location of at least one of the first and second storing areas may be indicated in a navigation area. Alternatively, the indication may be in the Lead-In (LI) area of the record carrier.

Further advantageous modifications or developments are defined in the dependent claims.

The present invention will now be described on the basis of a preferred embodiment with reference to the accompanying drawing, in which:

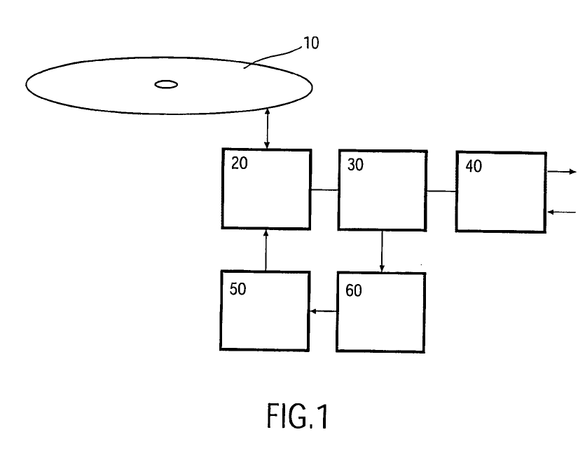

FIG. 1 shows a schematic block diagram of a storage device according to the preferred embodiment;

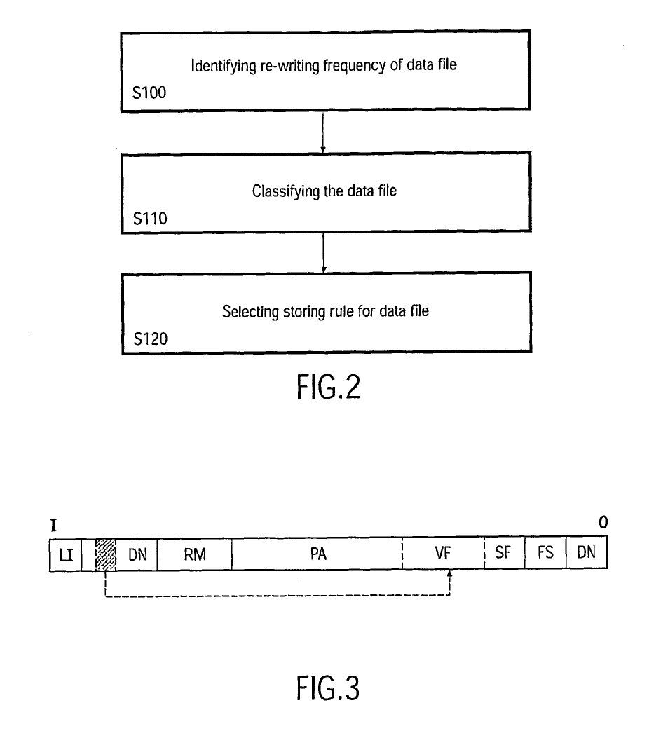

FIG. 2 shows a schematic flow diagram of a storing method according to the preferred embodiment; and

FIG. 3 shows a logical format of an information area for a record carrier according to the preferred embodiment.

The preferred embodiment will now be described on the basis of an SFFO device. FIG. 1 shows a schematic diagram of those blocks of the SFFO device, which are required to describe the present invention.

Optical recording technologies rely on lasers as their source of light. The lasers used in optical disc data storage may be semiconductor laser diodes of the shortest possible wave length that can provide sufficient optical power for read/write/erase operations. Such a laser is included in an optical system 20 where the laser beam is collimated by a well-corrected lens and directed towards an objective lens through a beam splitter. The objective lens focuses the beam onto a rewritable disc 10 and collects the reflected light. This reflected light is directed at the beam splitter towards detectors which produce a data readout signal as well as servo signals for automatic focussing and tracking.

The information on the disc 10 is recorded either along a series of concentric circular tracks or on a continuous spiral. Writable or rewritable media require a tracking mechanism distinct from the data pattern, because prior to the recording of data, a write head of the optical system must be able to follow the track before it can record anything. Once the data are recorded, the system will have a choice to follow the original tracking mechanism or to follow the recorded data pattern. As an alternative, a sampled servo-tracking scheme may be implemented, where a set of discrete pairs of marks is placed on the media at regular intervals.

In erasable phase-change recording, the recording process turns small regions of the recording medium into amorphous marks, by rising the local temperature above the melting point and allowing a rapid cool down quenching. The reflectivity of the amorphous mark is different from that of the polycrystalline background and, therefore, a signal is developed during readout. Erasure is achieved by using a laser pulse of an intermediate power level. If sufficient time is allowed for the laser beam to dwell on the amorphous mark, the mark will become crystalline once again. This process is compatible with direct overwrite and is therefore preferable to magneto-optical (MO) recording, where direct overwrite is harder to achieve.

Readout and write signals or data are supplied or respectively output through an input/output interface circuit 40 which is connected to the optical system 20 via a data or signal processing stage 30. This processing stage 30 is adapted to identify the rewriting frequency of individual data files written on the disc 10. The identified rewriting frequency is supplied to a classification stage 60, which may be a separate stage or may be part of the processing stage 30. Based on the classification of a data file to be written onto the disc 10, as obtained from the classification stage 30, a writing control stage 50 controls the optical system 20 to write the classified data file based on a storing rule defined for the obtained class of the data file. The definition of the allocation class based on the rewriting frequency may comprise two parts. First, certain data files can be identified as volatile files. Second, rules for storing such volatile files can be defined. By this definition of a volatile file allocation class and rules to store such volatile files, the storage can be optimized for high endurance an low power consumption.

FIG. 2 shows a schematic flow diagram of a storing or writing process according to the preferred embodiment. In an initial step S100, the rewriting frequency of a current data file to be written is identified. This can be achieved beforehand or a priori based on the type of data file, e.g. the expected rewriting frequency of each type of file. On the other hand, the rewriting frequency can be identified during use or operation of the system, e.g. based on the time period between subsequent writing operations of a specific data file or the amount of writing operations of the specific data file within a predetermined time period. In the subsequent step S110, the data file is classified based on the identified rewriting frequency, e.g. as a volatile file or a non-volatile file. As an example, a data file expected to be written more than a third of the recyclability of the recording medium in a year, e.g. once a day, can be classified as being a volatile file. Alternatively, a data file observed to be written once a day may also be classified as a volatile file. Based on this classification or class allocation for volatile files, a rule for storing the concerned data file is selected in step S120. This storing rule may address recyclability, e.g. by introducing frequent relocations, and/or write optimizations to reduce power consumption. Of course, other rules defining a differentiation between volatile files and non-volatile files can be implemented. Data files assigned to a volatile allocation class may be prime targets for a cashing operation to reduce the amount of times they are actually written.

Hence, by applying the proposed additional classification and adapted storing measures, optical drives, such as SFFO drives, can be used as HDD type storage devices, with increased life span and optimized power consumption.

SFFO is a storage solution typically used in an environment which is constrained with regard to power. SFFO also uses a constant angular velocity for reasons of power conservation. This means that read and write speed at an outer radial position on the disc is higher than at an inner radial position on the disc. Therefore, files which are accessed often, i.e. volatile files, should preferably be stored at an outer radial position, i.e. on the outside portion of the disc 10. This can be achieved by defining the above volatile file allocation class for SFFO devices.

FIG. 3 shows a logical format of an information area provided on the disc 10. The information area consists of a Lead-In area LI, a Lead-Out area LO, a Disc Navigation area DN, a digital rights management area RM, a program area PA, a volatile file area VF, a start-up file area SF, and a file system area FS. The Disk Navigation area DN and/or the digital rights management area RM may be part of the Lead-In area LI. The left end of the information area corresponds to the inside portion I of the disc 10 while the right side of the information area corresponds to the outside O of the disc 10. The Lead-In area LI is a small area outside the logical address space to aid physical navigation to the start of the address space. The Lead-Out area LO is a small area outside the logical address space to aid physical navigation to the end of the address space. The disc navigation DN is a space reserved for pointers and application specific data. These pointers can be used to effectively partition the disc 10 into separate areas. Furthermore, the disc navigation area DN can be used to determine the location of an initial address number in the logical address space for the disc 10 as whole or for a specific application. Additionally, the disc navigation area DN can be used for reserving space in the program area for specific file systems, allocation classes or applications, for assigning properties or attributes to the reserved space, and/or for providing pointers into the reserved space and room for application specific data. The rights management area RM is a special, mandatory area reserved on the inside of the disc 10 digital rights management (DRM). The program area PA comprises an area for user data and an area reserved for the file system. The starting point of these areas are recorded in the disc navigation area DN, as well as optionally their size.

For certified allocation classes, specific areas can be reserved in the program area. These classes may comprise volatile files which are files of a certain size that are written often. As indicated in FIG. 3, the volatile file area VF is located towards the outside of the disc 10 to achieve a high writing speed. The volatile files may be relocated, e.g., each time they are written. The space reserved for the volatile files should thus be at least double of the expected combined size of the volatile files. Another option could be to record the allocation history of the volatile files in the disc navigation area DN and re-allocation them if written as many times as half the expected recyclability of the medium.

The start-up file area SF is used for files required by applications to start their operation. Consequently, the start-up files need to be read each time the application is started. Finally, a file system such as UDF (Universal Disc Format) is used for storing file system data in the FS area.

As can be gathered from FIG. 3, the hatched area in the disc navigation area DN indicates a pointer or address of a specific volatile file in the volatile file area VF. Thus, in the drive navigation area DN the preferred location for volatile files is recorded. This address space can be reserved exclusively for volatile files. By default, this location may be positioned towards the outer radial position or the outside portion of the disc 10. This reduces the time needed to write the file and minimizes the time the laser needs to be switched on. However, it is noted, that the outside portion of the disc does not necessarily mean the upper end of the address space. Other allocation classes, e.g. file system structures or start-up files, may take precedence when assigning the outermost parts of the disc 10, as indicated in FIG. 3.

Additionally, another rule applies for volatile files, as already indicated above. If a file is determined to be re-written, e.g. by the processing stage 30, the writing control stage 50 is controlled to write this file to a different location than the previous version of the same file. This can be achieved most simply by first writing the new version of the file and then deleting the old version.

This relocation principle could be refined by having the system keep track of the allocation history for volatile files to thereby ensure that the second time a file is rewritten it is not written to the original location.

Furthermore, a loop recording scheme as specified in the Blue-ray Disc System Description Rewritable Format part 2 (File System Specification) could be used. According to this scheme, the last written address is kept in a memory or on the disk 10. The next time the file is written, it is written at the next free space in the reserved area for this kind of files. Thereby, the area, e.g. the volatile file area VF, is filled cyclically.

SFFO offers the opportunity to count the number of times a specific file is written. Thereby, volatile files can be identified without having to label such files. Moreover, the volatility of these files can be determined by counting the amount of writes, i.e. the number of times a data file is written within a predetermined time period. Combined with the tracking of the allocation history it can thus be achieved that even extremely volatile files do not tax the endurance of the recording medium too much by constantly relocating the most volatile files to a different location.

The volatile file area VF can be extended or replaced during the life time, if it is allowed to have other data files allocated in the reserved space for volatile files and start-up files. Playback compatibility is ensured by a corresponding information given in the file system area FS.

It is noted that the present invention is not intended to be restricted to the above preferred embodiment but can be used in any storage solution which offers an opportunity to take advantage of specific rules for storing data files which are written often, such as optical disk systems. Furthermore, any suitable storing rule can be applied based on the rewriting frequency of the data files, to thereby optimize the storing performance. The preferred embodiments may thus vary within the scope of the attached claims.

1. A storage device for storing a data file on a rewritable recording medium, said device comprising:
identification means for identifying a rewriting frequency of said data file;
classification means for classifying said data file based on said identified rewriting frequency; and
writing means for writing said data file on said rewritable recording medium using a rule selected according to the classification of said data file.

2. A storage device according to claim 1, wherein said classifying means is adapted to classify said data file as volatile file, if it is written or expected to be written more than a predetermined ratio of the recyclability of said rewritable recording medium.

3. A storage device according to claim 1, wherein said identifying means is arranged to identify said rewriting frequency by determining the amount of time until said data file has been re-written, or the number of times said data file is written within a predetermined time period.

4. A storage device according to claim 1, wherein said identifying means is arranged to identify said rewriting frequency based on the type of said data file.

5. A storage device according to claim 1, wherein said selected rule used by said writing means defines a write optimization for reduced power consumption.

6. A storage device according to claim 5, where said write optimization defines the location of a storage area on said recording medium.

7. A storage device according to claim 1, wherein said selected rule used by said writing means defines a relocation frequency.

8. A method of storing data files on a rewritable recording medium, said method comprising the steps of:
identifying a rewriting frequency of said data file;
classifying said data file based on said identified rewriting frequency; and
writing said data file on said rewritable recording medium using a rule selected according to the result of said classifying step.

9. A method according to claim 8, wherein said identification step is based on a detection of the amount of time until this data file re-written, or the number of times said data file is written within a predetermined time period.

10. A method according to claim 8, wherein said identification step is based on a detection of the type of said data file.

11. A method according to claim 8, wherein said selected rule defines a write optimization for reduced power consumption.

12. A method according to claim 11, wherein said write optimization rule defines the location of a storage area on said recording medium.

13. A method according to claim 8, wherein said selected rule defines a relocation frequency.

14. A rewritable record carrier for storing data files, said record carrier comprising a first storing area for storing data files re-written at a rewriting frequency within a first predetermined range, and a second storing area for storing data files re-written at a rewriting frequency within second predetermined range, wherein the rewriting frequencies of said first predetermined range are higher than the rewriting frequencies of said second predetermined range, and wherein the location of at least one of said first and second storing areas is indicated in a navigation area of said record carrier.

15. A record carrier according to claim 14, wherein said record carrier has a disk shape, and said first predetermined storing area is arranged at an outer radial portion of said disk-shaped record carrier.

16. A record carrier according to claim 14, wherein said record carrier is an SFFO disk.
